(19) United States
(12) Patent Application Publication
(10) Pub. No.: US 2015/0109515 A1
(43) Pub. Date: Apr. 23, 2015

(54) IMAGE PICKUP APPARATUS, IMAGE PICKUP SYSTEM, METHOD OF CONTROLLING IMAGE PICKUP APPARATUS, AND NON-TRANSITORY COMPUTER-READABLE STORAGE MEDIUM

(71) Applicant: CANON KABUSHIKI KAISHI, Tokyo (JP)

(72) Inventor: Takenori Kobuse, Kawasaki-shi (JP)

(21) Appl. No.: 14/511,287

(22) Filed: Oct. 10, 2014

(30) Foreign Application Priority Data
Oct. 18, 2013 (JP) 2013-216892

(51) Int. Cl. H04N 5/232

(52) U.S. Cl. CPC H04N 5/23212; H04N 5/23216; H04N 5/23245
USPC 348/349

(57) ABSTRACT

An image pickup apparatus includes an image pickup element configured to photoelectrically convert an optical image, an image processing unit configured to generate an image based on image signals acquired from a first region and a second region of the image pickup element, a focus detection unit configured to perform focus detection by a phase difference method based on the image signal acquired from the first region of the image pickup element, and a control unit configured to perform control so as to read the image signal acquired from the first region in a first mode and read the image signal acquired from the second region in a second mode different from the first mode.

### BACKGROUND OF THE INVENTION

1. Field of the Invention

The present invention relates to an image pickup apparatus which uses an image pickup element including a focus detection pixel to perform focus detection.

2. Description of the Related Art

With the growing increase in resolution of image pickup apparatuses in recent years, the number of pixels of image pickup elements has been increasing. For instance, compared with the resolution of an HD (High Definition) monitor which typically has 1920 pixels in a horizontal direction and 1080 pixels in a vertical direction (1920×1080 pixels), the resolution of the so-called 4k2k monitor, which is regarded as a next-generation monitor, has 3840×2160 pixels, which is four times as many as that of the HD monitor. In addition, standards developed for digital cinema is 4096×2160 pixels, which is greater than the number of pixels of the 4k2k monitor. Moreover, the so-called 8k4k standards, as next-generation standards of the 4k2k, are under consideration whose number of pixels is 7680×4320.

On the other hand, image pickup apparatuses capable of performing focus detection by an imaging plane phase difference method have been known which use the image pickup element including a focus detection pixel. Japanese Patent Laid-Open No. H4-267211 discloses an image pickup apparatus which uses a pair of pixels that receives light beams passing through a pair of pupil regions in an exit pupil of an image pickup lens (an image pickup optical system) to generate a focus detection signal by the imaging plane phase difference method.

However, employing the image pickup element disclosed in Japanese Patent Laid-Open No. H4-267211 in the image pickup apparatus with a high resolution results in an increase in the required number of pixels of the image pickup element, which inevitably increases power consumption of the image pickup element and that caused by image processing of the image pickup apparatus. On the other hand, performing thinning processing uniformly for a pixel region of the image pickup element makes it impossible to perform highly-accurate focus detection.

### SUMMARY OF THE INVENTION

The present invention provides an image pickup apparatus capable of performing highly-accurate focus detection with reduced power consumption, an image pickup system, a method of controlling the image pickup apparatus, and a non-transitory computer-readable storage medium.

An image pickup apparatus as one aspect of the present invention includes an image pickup element configured to photoelectrically convert an optical image, an image processing unit configured to generate an image based on image signals acquired from a first region and a second region of the image pickup element, a focus detection unit configured to perform focus detection by a phase difference method based on the image signal acquired from the first region of the image pickup element, and a control unit configured to perform control so as to read the image signal acquired from the first region in a first mode and read the image signal acquired from the second region in a second mode different from the first mode.

An image pickup system as another aspect of the present invention includes a lens apparatus including an image pickup optical system and the image pickup apparatus.

A method of controlling an image pickup apparatus as another aspect of the present invention includes the steps of using an image pickup element to photoelectrically convert an optical image, generating an image based on image signals acquired from a first region and a second region of the image pickup element, performing focus detection by a phase difference method based on the image signal acquired from the first region of the image pickup element, and reading the image signal acquired from the first region in a first mode and reading the image signal acquired from the second region in a second mode different from the first mode.

A non-transitory computer-readable storage medium as another aspect of the present invention is a computer-readable storage medium storing a program configured to cause a computer to execute each step of the method of controlling the image pickup apparatus.

Further features and aspects of the present invention will become apparent from the following description of exemplary embodiments with reference to the attached drawings.

### BRIEF DESCRIPTION OF THE DRAWINGS

FIG. 1 is a block diagram illustrating a configuration of an image pickup apparatus in each embodiment.

FIGS. 2A to 2C are block diagrams illustrating a configuration of an image pickup element in each embodiment.

FIGS. 3A to 3C are configuration diagrams of an image (a pixel of the image pickup element) in each embodiment.

FIG. 4 is a flowchart illustrating a method of controlling the image pickup apparatus in each embodiment.

FIG. 5 is an explanatory diagram of setting a full-pixel readout region in a second embodiment.

### DESCRIPTION OF THE EMBODIMENTS

Exemplary embodiments of the present invention will be described in detail below with reference to the accompanied drawings.

### First Embodiment

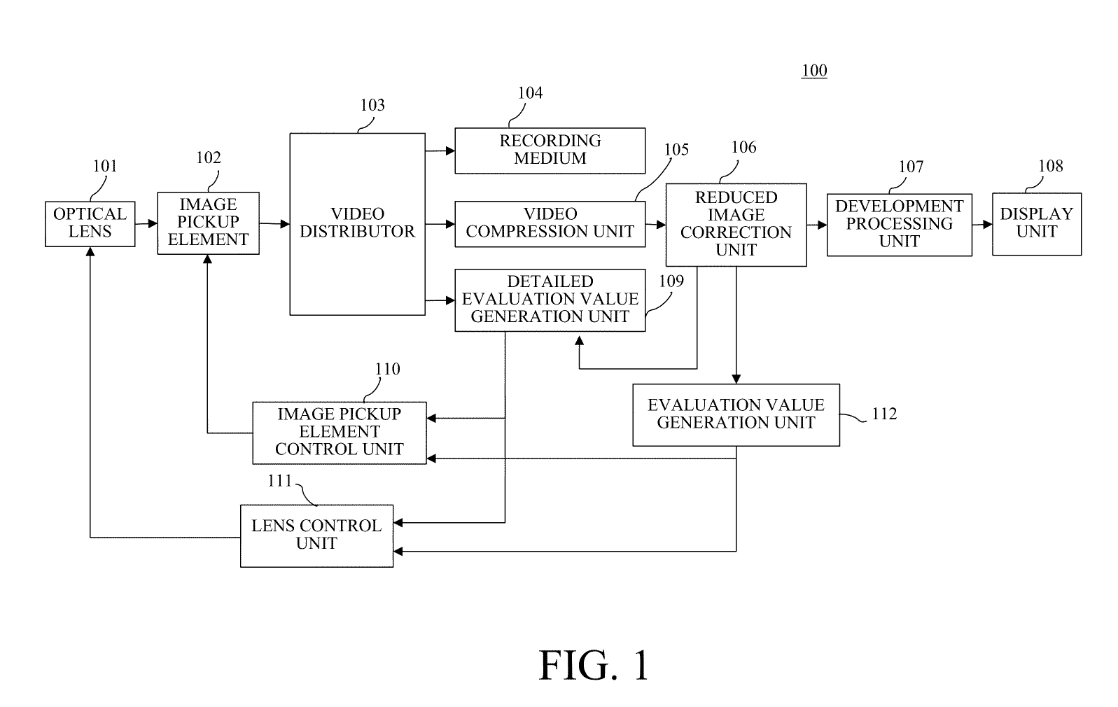

First of all, referring to FIG. 1, a description will be given of a schematic configuration of an image pickup apparatus in the first embodiment of the present invention. FIG. 1 is a block diagram illustrating a configuration of an image pickup apparatus 100 in this embodiment.

In FIG. 1, an optical lens 101 (an image pickup optical system) collects light of an object and includes a focus mechanism intended for focusing, a stop mechanism which controls a light amount and a depth of field, a zoom mechanism which varies a focal length, and the like. However, when the optical lens 101 is a single focus lens (fixed focal lens), the zoom mechanism is not necessary. In addition, when the optical lens 101 is a pan-focus lens (deep focus lens), the focus mechanism is not necessary because the lens is focused only at infinity. An ND filter which controls the light amount with a position of a stop being fixed may alternatively be used in order to reduce the cost of the optical lens 101. In this embodiment, the optical lens 101 refers to all lenses that form an image of the light on the image pickup element 102 to make the light incident thereon.

The image pickup element 102 receives the incident light (an object image or an optical image) from the optical lens 101 and then converts the incident light into an electrical signal (an analog signal). That is, the image pickup element 102 photoelectrically converts the optical image via the optical lens 101. The image pickup element 102 includes a CCD (Charge Coupled Device) image sensor, a CMOS (Complementary Metal-Oxide-Semiconductor) image sensor, or the like. As a video signal (an image signal) output from the image pickup element 102, the analog signal generated by the photoelectric conversion is directly output. This embodiment is, however, not limited to this. The image pickup element 102 may be configured, for example, to perform A/D (analog to digital) conversion processing therein to output digital data (an image signal) such as LVDS (Low Voltage Differential Signaling).

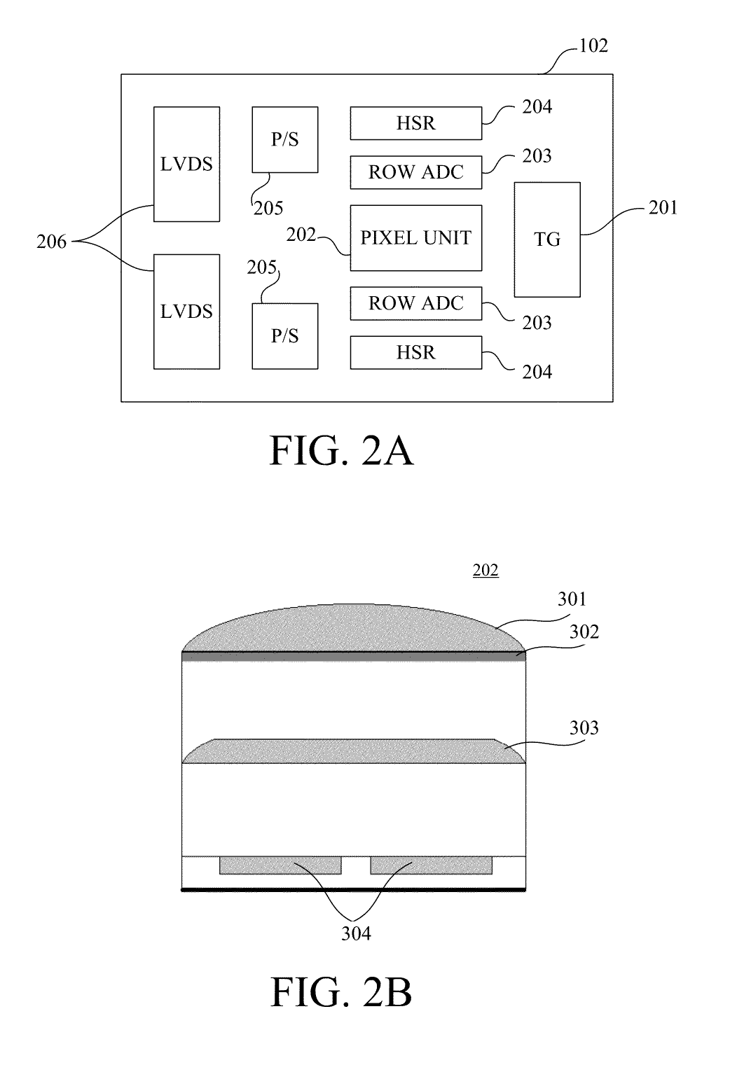

Subsequently, referring to FIGS. 2A to 2C, a configuration of the image pickup element 102 in this embodiment will be described. FIG. 2A is a block diagram illustrating the configuration of the image pickup element 102. In FIG. 2A, a TG 201 is a timing generator which controls drive (processing) of the image pickup apparatus 100 as a whole. A pixel unit 202 includes photo diodes which convert the light into the electrical signal and a floating diffusion amplifier, and transmits each pixel row to a row ADC 203 provided at a subsequent stage.

The row ADC 203 performs A/D conversion for the video signal (the analog signal) of each pixel output from the pixel unit 202 and then outputs the digital signal. An HSR 204 (a horizontal shift register) is a circuit which transfers the digital signal of each pixel column from the row ADC 203 to a P/S 205 (a parallel/serial conversion circuit). The P/S 205 is a circuit which converts the digital signal into a signal compatible with the LVDS used as an output method. A LVDS 206 is a drive circuit which outputs a serial signal converted by the P/S 205.

Subsequently, referring to FIG. 2B, a configuration of the pixel unit 202 will be described. FIG. 2B is a schematic diagram of a section structure of the pixel unit 202. A micro lens 301 is provided to cause the light illuminated to the image pickup element 102 to be efficiently incident on the photodiodes. Improving a light collection rate enables enhancing a sensitivity of the image pickup element 102. A color filter 302 disperses the incident light into three or four colors such as R, G, and B. The color filter 302 has, for example, a color filter structure called as a Bayer array.

An inner lens 303 is called also as an inner-layer lens and provided between the micro lens 301 and photodiodes 304. Typically, adoption of the inner lens 303 contributes to a reduction in size of each pixel, which enables enhancing the sensitivity of the image pickup element 102 also to a ray which has a sharp incident angle because an F number of a stop is small.

The photodiodes 304 are regions in which the photoelectrical conversion is to be performed to convert the incident light (the optical image) into an electron (the electrical signal). While typically one photodiode is provided to one micro lens 301 or one color filter 302, the plurality of (two or more) photodiodes 304 is provided to one micro lens 301 in the image pickup apparatus 100 of this embodiment. This structure is referred to as a “pupil-divided structure”, and a pixel having this structure is referred to as a “pupil-divided pixel”. In this structure, a plurality of circuits (two or more circuits) which read signals output from the photodiodes 304 are required for each micro lens. This is a way to realize the imaging-plane phase difference detection method described in the description of the related art, and performs the phase difference detection by comparing the video signals read from the two photodiodes 304.

Subsequently, referring to FIG. 2C, an array of a plurality of pixels (the pupil-divided pixels) of the image pickup element 102 will be described. FIG. 2C is a schematic diagram of the pupil-divided pixels as seen from an upper surface side of the image pickup element 102 and illustrates a configuration which divides the pixels of the image pickup element 102 arranged in the Bayer array into left and right pupil regions. Therefore, for instance, each R pixel includes two pixels R1L and R1R. Hereinafter, either of each L (left-side) pixel or each R (right-side) pixel is referred to as a “one-sided pixel” or both of them are collectively referred to as “both pixels”, respectively.

Power-downing a circuit (an inner circuit) for arbitrary pixels of the photodiodes 304 allows reducing power consumption of the image pickup apparatus 100. For instance, circuits such as circuits of a vertical read line of the pixel unit 202, the row ADC 203, and the like are not necessary for the pixels for which the signal is not to be read. For this reason, power-downing these circuits allows reducing the power consumption of the image pickup apparatus 100.

In FIG. 1, a video distributor 103 distributes the video signal (the image signal) from the image pickup element 102 to a plurality of elements. A recording medium 104 stores the full-sized video signal distributed from the video distributor 103. A video compression unit 105 performs shrink processing (reduction processing) which, for example, adds or thins the entire full-sized video signal distributed from the video distributor 103. This shrink processing reduces a video (an image) to the number of pixels with which FPN correction can be performed in real time by a reduced image correction unit 106 described later.

The reduced image correction unit 106 performs in real time the FPN correction of the image pickup element 102 and the like for the video signal shrunk by the video compression unit 105. The FPN correction is a general term for all of the corrections and the like of an OB clamp which determines a black level of the video signal, fixed-pattern noise (FPN), vertical line noise due to non-uniformity of sensitivity (PRNU), noise due to non-uniformity of dark current (DSNU), and a dot scratch due to defect of pixels. The FPN correction performed by the reduced image correction unit 106 includes all the processing which performs any correction in real time with respect to elements specific to the image pickup element 102.

A development processing unit 107 is an image processing unit which performs various image processing of the image pickup apparatus 100. The development processing unit 107 performs various development processing (image processing) such as noise reduction, gamma correction, knee correction, digital gain correction, and scratch correction. In addition, the development processing unit 107 is provided with a storage circuit which stores set values required for each correction and each image processing. As described later, the development processing unit 107 generates the image based on the image signals acquired from a first region (a full-pixel readout region) and a second region (a thinning readout region) of the image pickup element 102.

A display unit 108 is configured to display the image acquired from the development processing unit 107 and is, for example, a liquid crystal monitor or a view finder attached to the image pickup apparatus 100. A user of the image pickup apparatus 100 checks an angle of view, an exposure, and the like via the display unit 108.

A detailed evaluation value generation unit 109 uses the full-sized video signal distributed from the video distributor 103 to calculate (generate) an evaluation value of each of signals for the exposure, the focusing, hand-shake correction (image stabilizing processing), and the like. In this calculation (generation), the detailed evaluation value generation unit 109 receives FPN information and address information of the dot scratch which are detected by the reduced image correction unit 106 and then converts the address information into full-sized address information. Thereafter, the detailed evaluation value generation unit 109 excludes any address (pixels located at the address) that might be the FPN or the dot scratch from addresses (pixels located at the address) to be used to generate the evaluation value.

An image pickup element control unit 110 and a lens control unit 111 control the image pickup element 102 and the optical lens 101, respectively, based on the information, such as the exposure, the focus, and the hand-shake correction, acquired from the detailed evaluation value generation unit 109 such that the image pickup element 102 and the optical lens 101 are in a state optimum for recording the video (the image). The detailed evaluation value generation unit 109, an evaluation value generation unit 112, and the lens control unit 111 constitute a focus detection unit which performs the focus detection by the phase difference method (the imaging-plane phase difference method) based on the image signal acquired from the first region of the image pickup element 102. In addition, the detailed evaluation value generation unit 109, the evaluation value generation unit 112, and the image pickup element control unit 110 constitute a control unit. As described later, the control unit performs control so as to read the image signal acquired from the first region in a first mode, and read an image signal acquired from the second region in a second mode different from the first mode.

The evaluation value generation unit 112 calculates an in-focus position to be used for AF (autofocusing), a lightness of the video to be used for exposure control, a shake amount and a vector which are to be used for the hand-shake correction, and the like (various evaluation values) based on the signal (the reduced image which has been subjected to the FPN correction) from the reduced image correction unit 106. For instance, it is possible to first use the in-focus position calculated based on the reduced image to focus on the object and to then use the in-focus position calculated based on the full-sized image to finely focus on the object.

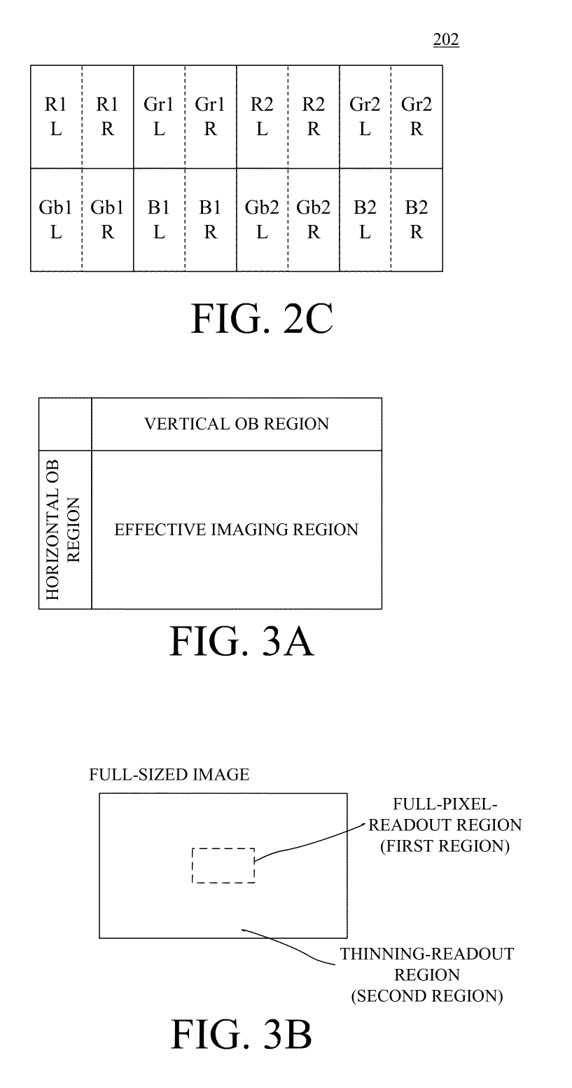

Next, referring to FIGS. 3A to 3C, a description will be given of operations of the image pickup element 102, the video compression unit 105, the detailed evaluation value generation unit 109, and the evaluation value generation unit 112 in the image pickup apparatus 100. While a description will be given in this embodiment of a case where a center portion of a screen is focused and a signal readout of the image pickup element 102 is set to ½ pixel thinning, applicable configurations are not limited to this.

First, referring to FIGS. 3A and 3B, a description will be given of a typical pixel configuration of the image pickup element 102 and a configuration of an output image. FIGS. 3A and 3B are diagrams illustrating the pixel configuration of the image pickup element 102 and the output image, respectively. In FIG. 3A, each pixel of the image pickup element 102 has an effective imaging region in which the light from the optical lens 101 is received and then converted into the video signal and an optical black (OB) region in which the light from the optical lens 101 is shielded to output a black level. In particular, a region located at an upper or lower side of the effective imaging region is referred to as a “vertical OB region” and a region located at a left or right side of the effective imaging region is referred to as a “horizontal OB region”, respectively. These OB regions are mainly used in horizontal OB clamping for determining (adjusting) the black level of the video signal and in the FPN correction of the image pickup element 102.

When the center portion of the screen is to be focused, full pixel readout is performed for an arbitrary center region (the first region) as a focus calculation region (a focus detection region) as illustrated in FIG. 3B. Since the full pixel readout is performed, the focus detection (in-focus control) by the phase difference method (the imaging-plane phase difference detection method) can be performed for this readout region (the center region: the first region). Thinning readout is performed for the region (the second region) other than the center region.

FIG. 3C is a diagram illustrating a pixel array. Since the control unit is configured to perform the ½ pixel readout in this embodiment, the control unit reads white pixels illustrated in FIG. 3C and, on the other hand, does not read (power-down) black pixels. A plurality of pixels illustrated in FIG. 3C is pixels whose pupil is to be divided in the horizontal direction. For this reason, each four pixel is read in the horizontal direction and each two pixel is read in the vertical direction. While L pixels are set as the pixels to be read in the example in FIG. 3C, applicable setting are not limited to this. As the pixels to be read, R pixels, a combination of the L pixels and R pixels, or other combination may alternatively be used.

The detailed evaluation value generation unit 109 receives, from the video distributor 103, the video signal read from the image pickup element 102. Thereafter, the detailed evaluation value generation unit 109 performs the imaging-plane phase difference detection by using the pixels located in the center full-pixel readout region (the first region) to calculate a focus position (performs AF control). The detailed evaluation value generation unit 109 may also calculate the evaluation values on the exposure, the hand-shake correction, and the like.

The video compression unit 105 receives, from the video distributor 103, the video signal read from the image pickup element 102. Thereafter, the video compression unit 105 performs the thinning processing for the pixels located in the center full-pixel readout region (the first region) such that the pixels are arranged at the same degree of distance as that in the other thinning readout region (the second region) and then outputs the video signal which has been subjected to the thinning processing to the development processing unit 107 provided at the subsequent stage. The evaluation value generation unit 112 uses the reduced video (the reduced image) which has been subjected to the FPN correction to calculate the in-focus position to be used for AF, the lightness of the video to be used for the exposure control, the shake amount and the vector which are to be used for the hand-shake correction, and the like. The image pickup element control unit 110 and the lens control unit 111 control the image pickup element 102 and the optical lens 101, respectively, based on the evaluation values from the detailed evaluation value generation unit 109 and on the evaluation values based on the reduction image from the evaluation value generation unit 112.

While the image pickup apparatus 100 of this embodiment is configured to be integrated with the optical lens 101, applicable configurations are not limited to this. This embodiment is applicable also to an image pickup system constituted by the combination of an image pickup apparatus body and a lens apparatus (a lens apparatus including the image pickup optical system) detachably mounted on the image pickup apparatus body.

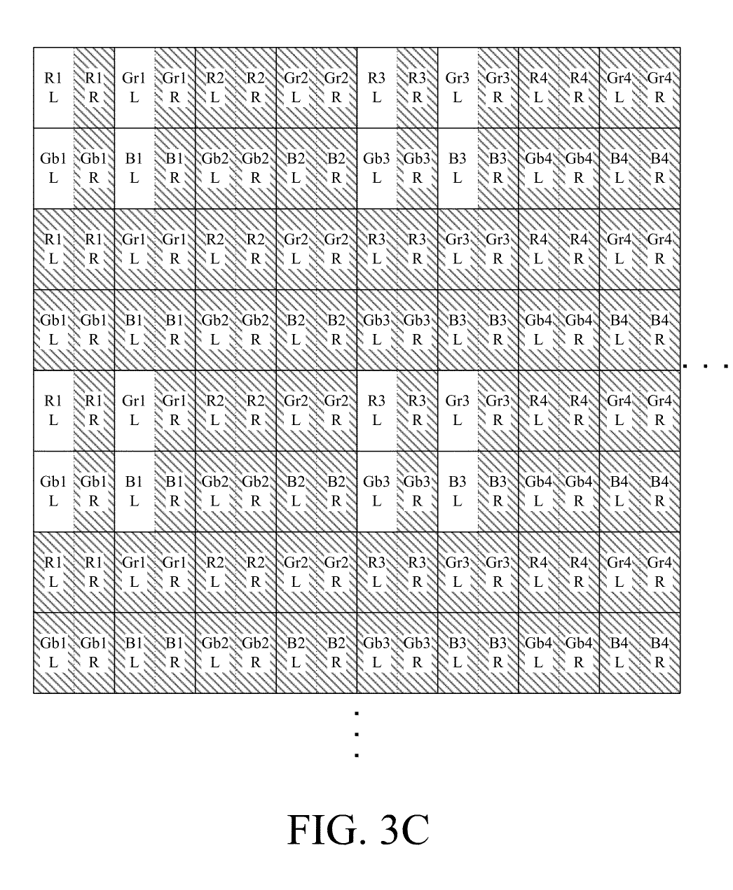

Next, a description will be given of a period in which the power consumption due to the thinning readout is reduced. It is preferable that the period in which the power consumption is reduced is during a state in which the image pickup apparatus 100 is not recording the video in the recording medium 104 (i.e., during waiting for video recording) and is calculating the in-focus position for the focusing (i.e., during detecting the focus position). Subsequently, referring to FIG. 4, a method of controlling the image pickup apparatus 100 in this embodiment will be described. FIG. 4 is a flowchart illustrating the method of controlling the image pickup apparatus 100. Each step of FIG. 4 is performed mainly by the control unit (the detailed evaluation value generation unit 109, the evaluation value generation unit 112, and the image pickup element control unit 110).

First, at step S11, the detailed evaluation value generation unit 109 determines whether or not the video is being recorded (the image is being recorded in the recording medium 104). When the video is being recorded, the control unit performs the full-pixel readout from the image pickup element 102 in order to perform high-quality recording. That is, the control unit reads all pixels (the pixels included in the first and second regions) in the first mode. On the other hand, the flow proceeds to step S12 when the video is not being recorded.

At step S12, the detailed evaluation value generation unit 109 determines whether or not the AF is being performed, namely, the focus detection is being performed. The flow proceeds to step S14 when the AF is not being performed. Since it is not necessary to perform the imaging-plane phase difference detection, the control unit performs the thinning readout for all pixels in the second mode at step S14. That is, the control unit reads all pixels (the pixels included in the first and second regions) in the second mode. This enables a maximum reduction in the power consumption.

On the other hand, the flow proceeds to step S13 when the AF is being performed at step S12. At step S13, in order to perform the focus detection by the phase difference detection (the imaging-plane phase difference detection), as described above, the control unit performs the full-pixel readout for the pixels located in the center region (the first region) and performs the thinning readout for the pixels located in a surrounding region (the second region). That is, the detailed evaluation value generation unit 109 performs the control so as to read the image signal acquired from the first region in the first mode, and read the image signal acquired from the second region in the second mode different from the first mode (the combination of the first mode and the second mode). Preferably, the number of pixels to be thinned out is set based on the number of pixels of the display unit 108. For instance, when the number of pixels of an LCD panel of the display unit 108 is 1920×1080 pixels, which is so-called the full HD, it is enough to perform ¼ pixel thinning (⅛ thinning in the horizontal direction when the number of pixels thinned out by the pupil division is taken into account) for the pixels of the image pickup element 102 whose number is 7680 (which is increased to 15360 by the pupil division)×4320.

As described above, the control unit performs the control so as to read, in the first mode, the image signal acquired from the first region and read, in the second mode different from the first mode, the image signal acquired from the second region. Preferably, the power consumption caused by the control performed in the second mode is lower than the control performed in the first mode.

Preferably, the first mode is a mode which reads the image signal from all of the pixels located in the first region of the image pickup element 102 (a full-pixel readout mode). Similarly, the second mode is a mode which reads the image signal from part of the pixels located in the second region of the image pickup element 102 (a thinning readout mode). The first mode is, however, not limited to the full-pixel readout mode. Alternatively, the first mode may be a mode which reads part of the pixels located in the first region of the image pickup element 102 and the second mode may be a mode which reads part of the pixels located in the second region of the image pickup element 102. In this case, a thinning rate of the pixels read in the second mode is larger than that of the pixels read in the first mode.

Preferably, the control unit reads, in the first mode, the image signal with respect to the pixels located in the first region and reads, in the second mode, the image signal with respect to the pixels located in the second region while the focus detection is performed. Similarly, the control unit reads, in the second mode, the image signal with respect to the pixels located in the first and second regions while the focus detection is not performed. In addition, preferably, the control unit reads, in the first mode, the image signal with respect to the pixels located in the first and second regions while the image is recorded. More preferably, the control unit performs the control so as to read, in the second mode, only one side of the pupil-divided pixels which are the pixels located in the second region. In addition, more preferably, the control unit sets (changes) the first and second regions based on the number of pixels of the display unit 108.

According to the image pickup apparatus of this embodiment, it is possible to change the mode to read the image signal from the image pickup element with the pupil-divided pixels for each region when the apparatus is waiting for the recording and is performing the AF. This allows achieving a reduction in power consumption of the image pickup apparatus while calculating the in-focus position. As described above, according to this embodiment, changing a method of reading performed by the image pickup element for each region enables a reduction in power consumption of the image pickup apparatus without decreasing a focusing accuracy.

### Second Embodiment

Next, an image pickup apparatus in the second embodiment of the present invention will be described. In the first embodiment, a center region is set as a full-pixel readout region (a first region) of an image pickup element 102. On the other hand, in this embodiment, a description will be given of a configuration which detects an object (a face) and a configuration which uses a display unit 108 to change a readout region.

As for recent image pickup apparatuses, a touch panel is mainly employed as a display unit 108 in many cases. The touch panel is an electronic component constituted by a combination of a display device such as a liquid crystal panel and a position input device such as a touch pad, and is also an input device on which a user touches (operates) icons on a screen to give an instruction on operations of the image pickup apparatus. In addition, the touch panel is mainly integrated with devices which require intuitive operations. The touch panel is called also as a touch screen or a touch window.

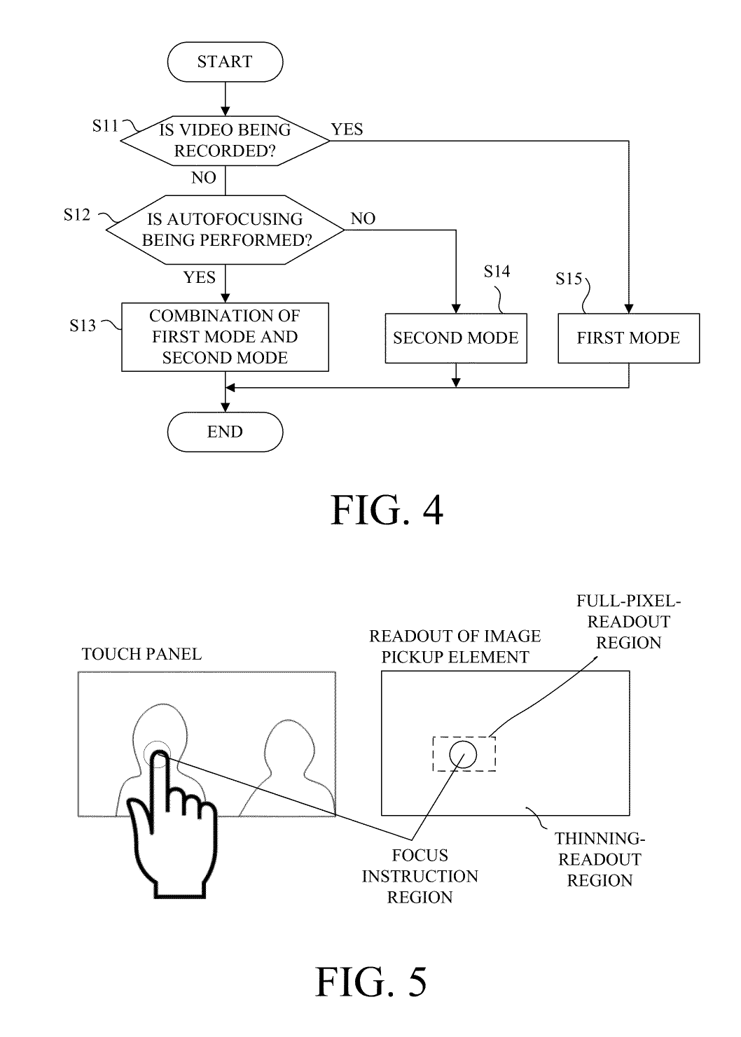

Referring to FIG. 5, a description will be given of a method of setting (changing) the full-pixel readout region (the first region) of the image pickup element 102 with use of a touch panel in this embodiment. FIG. 5 is an explanatory diagram of the setting the full-pixel readout region (the first region) and is also a schematic diagram of an operation of setting (changing) the full-pixel readout region of the image pickup element 102 using the touch panel. The user touches with a finger a portion of an entire displayed video (an image) to be focused (an object to be subject to focus detection). The control unit (a detailed evaluation value generation unit 109, an evaluation value generation unit 112, an image pickup element control unit 110, or other microcomputer in an image pickup apparatus 100) recognizes the portion set by this operation (the touch) as a focus instruction region.

The image pickup element control unit 110 sets (changes), as the full-pixel readout region (the first region), a region present within an arbitrary range whose center is the focus instruction region based on information on the focus instruction region. In addition, the image pickup element control unit 110 sets (changes), as the thinning readout region (a second region), a region surrounding the region located within the arbitrary range whose center is the focus instruction region (the second region different from the first region).

While the control unit of this embodiment is configured to set (change) the first and second regions according to the region specified by the user with the touch panel, applicable settings (changes) are not limited to this. For example, when the image pickup apparatus of this embodiment includes an object detection unit which detects an object such as a face of a person, the control unit may set (change) the first and second regions based on a position of the object (the face) detected by the object detection unit.

As described above, preferably, the image pickup apparatus further includes the touch panel capable of determining the instruction given by the user. The control unit sets (changes) the first and second regions based on the position specified via the touch panel. Preferably, the image pickup apparatus includes the object detection unit which detects the object (the face). The control unit sets (changes) the first and second regions based on the position of the object detected by the object detection unit.

According to this embodiment, changing the reading method performed by the image pickup element for each region depending on the region intended by the user or on the position of the object detected by the object detection unit enables a reduction in power consumption of the image pickup apparatus without decreasing a focusing accuracy.

According to the embodiments, it is possible to provide an image pickup apparatus capable of performing highly-accurate focus detection with reduced power consumption, an image pickup system, a method of controlling the image pickup apparatus, and a non-transitory computer-readable storage medium.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-216892, filed on Oct. 18, 2013, which is hereby incorporated by reference herein in its entirety.

What is claimed is:

1. An image pickup apparatus comprising:
an image pickup element configured to photoelectrically convert an optical image;
an image processing unit configured to generate an image based on image signals acquired from a first region and a second region of the image pickup element;
a focus detection unit configured to perform focus detection by a phase difference method based on the image signal acquired from the first region of the image pickup element; and
a control unit configured to perform control so as to read the image signal acquired from the first region in a first mode and read the image signal acquired from the second region in a second mode different from the first mode.

2. The image pickup apparatus according to claim 1, wherein power consumption caused by the control performed in the second mode is lower than power consumption caused by the control performed in the first mode.

3. The image pickup apparatus according to claim 1,
wherein the first mode is a mode which reads the image signal from part of pixels located in the first region of the image pickup element,
wherein the second mode is a mode which reads the image signal from part of pixels located in the second region of the image pickup element, and
wherein a thinning rate of the pixels read in the second mode is larger than a thinning rate of the pixels read in the first mode.

4. The image pickup apparatus according to claim 1,
wherein the first mode is a mode which reads the image signal from all of pixels located in the first region of the image pickup element, and
wherein the second mode is a mode which reads the image signal from part of pixels located in the second region of the image pickup element.

5. The image pickup apparatus according to claim 1, wherein while the focus detection unit performs the focus detection, the control unit is configured to: read the image signal in the first mode with respect to pixels located in the first region of the image pickup element, and
read the image signal in the second mode with respect to pixels located in the second region of the image pickup element.

6. The image pickup apparatus according to claim 5, wherein while the focus detection unit does not perform the focus detection, the control unit is configured to read the image signals in the second mode with respect to the pixels located in the first and second regions.

7. The image pickup apparatus according to claim 1, wherein, during recording the image, the control unit is configured to read the image signals in the first mode with respect to pixels located in the first and second regions.

8. The image pickup apparatus according to claim 1, wherein the control unit is configured to perform the control so as to read, in the second mode, only one side of pupil-divided pixels of the pixels located in the second region.

9. The image pickup apparatus according to claim 1, further comprising a touch panel capable of determining an instruction given by a user,
wherein the control unit is configured to set the first and second regions based on a position specified via the touch panel.

10. The image pickup apparatus according to claim 1, further comprising an object detection unit configured to detect an object,
wherein the control unit is configured to set the first and second regions based on a position of the object detected by the object detection unit.

11. The image pickup apparatus according to claim 1, wherein the control unit is configured to set the first and second regions based on the number of pixels of a display unit.

12. An image pickup system comprising:
a lens apparatus including an image pickup optical system; and
an image pickup apparatus,
wherein the image pickup apparatus comprises:
an image pickup element configured to photoelectrically convert an optical image;
an image processing unit configured to generate an image based on image signals acquired from a first region and a second region of the image pickup element;
a focus detection unit configured to perform focus detection by a phase difference method based on the image signal acquired from the first region of the image pickup element; and
a control unit configured to perform control so as to read the image signal acquired from the first region in a first mode and read the image signal acquired from the second region in a second mode different from the first mode.

13. A method of controlling an image pickup apparatus, the method comprising the steps of:
using an image pickup element to photoelectrically convert an optical image;
generating an image based on image signals acquired from a first region and a second region of the image pickup element;
performing focus detection by a phase difference method based on the image signal acquired from the first region of the image pickup element; and
reading the image signal acquired from the first region in a first mode and reading the image signal acquired from the second region in a second mode different from the first mode.

14. The method of controlling the image pickup apparatus according to claim 13,
wherein the first mode is a mode which reads the image signal from all of pixels located in the first region of the image pickup element, and
wherein the second mode is a mode which reads the image signal from part of pixels located in the second region of the image pickup element.

15. A non-transitory computer-readable storage medium storing a program configured to cause a computer which controls an image pickup apparatus to execute a process comprising the steps of:
using an image pickup element to photoelectrically convert an optical image;
generating an image based on image signals acquired from a first region and a second region of the image pickup element;
performing focus detection by a phase difference method based on the image signal acquired from the first region of the image pickup element; and
reading the image signal acquired from the first region in a first mode and reading the image signal acquired from the second region in a second mode different from the first mode.

16. The non-transitory computer-readable storage medium according to claim 15,
wherein the first mode is a mode which reads the image signal from all of pixels located in the first region of the image pickup element, and
wherein the second mode is a mode which reads the image signal from part of pixels located in the second region of the image pickup element.
